(19) United States
(12) Patent Application Publication
(10) Pub. No.: US 2004/0131088 A1
(43) Pub. Date: Jul. 8, 2004

(54) Shared T1/E1 signaling bit processor

(75) Inventors: Clarke Edgar Moore, Huntsville, AL (US); Dwight Edwin Wright, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., Huntsville, AL

(21) Appl. No.: 10/338,461

(22) Filed: Jan. 8, 2003

(51) Int. Cl. H04J 3/12

(52) U.S. Cl. 370/523

(57) ABSTRACT

A shared T1/E1 signaling bit processor interfaces with either T1 or E1 traffic, and controllably performs robbed bit signal extraction and insertion for T1/E1 signaling protocol using a common set of input/output circuitry and associated decode/control logic therefor. A receiver subsystem controllably samples and extracts signaling bits from selected time slots within serial frames of data incoming from the network to the DTE for delivery to the control processor; a transmitter subsystem controllably inserts signaling bits into selected signaling channels of serial frames of data outgoing from the DTE to the network.

### CROSS-REFERENCE TO RELATED APPLICATION

The present application relates in general to subject matter disclosed in co-pending U.S. patent application Ser. No. 10/______, filed on even date herewith, by Charles David Capps et al, entitled: “Programmable Network-DTE Interface Containing Selectively Enabled T1/E1 Framer, Data Pump and Microprocessor” (hereinafter referred to as the '______ application), assigned to the assignee of the present application and the disclosure of which is incorporated herein.

### FIELD OF THE INVENTION

The present invention relates in general to digital telecommunication systems, and is particularly directed to a ‘robbed’ bit signaling mechanism that is capable of controllably extracting and injecting signaling bits for either T1 or E1 signaling protocol using a common set of input/output circuitry and associated decode/control logic therefor.

### BACKGROUND OF THE INVENTION

With the ongoing demand for increased bandwidth capacity, digital network service providers are continuously seeking ways to extract more performance from their existing communication network infrastructures. In particular, although voice transport demand has not diminished, there is a continuing demand for more bandwidth, so that both voice and data are typically transported over the same channelized path (e.g., local loop). In the United States, the existing digital communication infrastructure employs basic rate (T1) channelized time division multiplexed (TDM) digital communication protocol, which is defined as twenty-four DS0 (e.g., voice) channels, each providing 64 Kbps worth of bandwidth, for a total or cumulative T1 bandwidth capacity of 1.536 Mbps.

As shown in the time slot/channel diagram of FIG. 1, a respective channelized T1 TDM frame contains twenty-four, eight-bit bytes or time slots TS1-TS24, plus a frame sync bit, for a total of 193 bits per T1 frame (which corresponds to an overall clock rate of 1.544 Mhz). In order to convey signaling information for a respective DS0 voice channel time slot TSi, selected ones of least significant information bits, termed A/B (C/D) bits, depending upon whether superframe (SF) or extended superframe (ESF) protocol is employed, are periodically ‘robbed’ from every sixth frame and used as ‘signaling’ bits. Voice signals are encoded using mu-law coding.

Non-domestic networks, on the other hand, such as those installed in Europe, and Central and South America, employ E1 rate channelized TDM digital communication protocol, which has a higher overall clock rate (2.048 MHz) and a higher available information transport bandwidth capacity (1.920 Mbps). As shown in the time slot/channel diagram of FIG. 2, every E1 frame contains thirty-two, eight-bit bytes/time slots TS0-TS31. Of these thirty-two time channels/time slots, the first time slot or channel TS0 is reserved as a frame synchronization channel, while channel sixteen TS16 is used to convey signalling information. Voice is encoded using A-law coding. The remaining thirty channels (TS1-TS15 and TS17-TS31) provide a total available information transport bandwidth capacity of 1.920 Mbps.

Because of differences in their framing structures and the fact that their signaling coding schemes and voice encoding (mu-law vs. A-law) are mutually incompatible, T1 networks and E1 networks cannot ordinarily be interchanged for one another. Instead, the two are customarily interfaced by means of a relatively complex network converter arrangement (a T1-E1 converter when going from a T1 system (e.g., in the United States) to an E1 system (e.g., in Mexico), and an E1-T1 converter when going from an E1 to an T1 system).

### SUMMARY OF THE INVENTION

The present invention is directed to a receive/transmit signaling processor interface that is configured to be interfaced with either T1 or E1 digital communication traffic, and is operative to controllably perform robbed bit signal extraction and insertion for T1 or E1 TDM signaling protocol using a common set of input/output circuitry and associated decode/control logic therefor. As will be detailed below, the shared T1/E1 signaling processor of the invention contains two subsystems—a receiver subsystem and a transmitter subsystem.

The receiver subsystem is configured to controllably sample and extract signaling bits from selected signaling bit-containing time slots or channels within serial frames of TDM data incoming from the network to the DTE for delivery to the control processor. The principal components of the shared T1/E1 receiver subsystem include a decoder unit, a shift register into which extracted signaling bits for either protocol are captured, and a data overwrite multiplexer.

Conversely, the transmitter subsystem is configured to controllably insert signaling bits into selected signaling time channels of serial frames of TDM data outgoing from the DTE to the network. Principal components of the transmitter subsystem include a decoder unit, a signaling bit multiplexer unit, a signaling bit storage and supply shift register unit, an output decoder, an output multiplexer, and a data overwrite multiplexer.

The receiver subsystem's decoder unit monitors a set of control links from the framer and the processor, and selectively enables the loading of selected stages of the shift register unit with sampled portions of the received data stream containing the signaling bits as received over a serial data path coupled through a multiplexer to the data pump. To accommodate both T1 and E1 frames, the receiver subsystem's signaling bit capture shift register unit is comprised of sixteen, byte-deep register stages.

For T1 mode, signaling bits within the twenty-four time slots (TS1-TS24) of an arbitrary sixth frame of T1 TDM data will be sequentially loaded into the three successive register stages of the set of sixteen. For E1 mode, the eight signaling bits of time slot sixteen of every frame of E1 TDM data, except the first frame (F1), namely frames F2-F16, will be sequentially loaded into fifteen sequential stages of the signaling bit shift register.

In order to accurately control the extraction of the signaling bits from an serial data stream incoming from the network, a number of control parameters are supplied to the decoder unit from the framer and from the control processor. A first input is a sync input which is aligned with the beginning of each successive frame of data. A second input is a loss of sync bit. In the event of loss of sync, the processor terminates signaling recovery. Otherwise, incoming data is valid for signaling bit recovery. A third, frame type, control bit cT1E1Not is used to identify whether the data frame is T1 data or E1 data. A fourth, T1 frame type control input CEsfSNot represents whether the T1 frame has superframe (SF) or extended superframe (ESF) format.

A fifth, frame number, port is used to indicate number of the current frame of data being processed. In T1 mode, the processor will remain idle until the input to the frame Number port indicates the current frame is an integral multiple of six. A sixth, channel or time slot, port indicates in which time slot a signaling bit of a currently received frame of data resides. For each frame of T1 data, this value increments from TS1-TS24, whereas for each frame of E1 data this value increments from TS1-TS16. A seventh, bitNow port from the framer indicates the location of the current bit within the current time slot. For a T1 data frame, it is not until this port specifies the MSB of a signaling frame time slot, that the data on the link may be sampled as a valid signaling bit. The decoder unit also has a ninth, Rsao-en, port which is coupled to receive a T1 signal masking bit, used to deliberately overwrite a ‘1’ at the corresponding signaling position in the data stream.

In T1 mode of operation (SF or ESF), the T1/E1 signaling processor remains idle until the frame Number port indicates that the current frame is the sixth frame of a multi-frame T1 sequence. When the binary value presented to the bitNow port corresponds to the most significant bit position of the first time slot, the processor will sample the input data (the robbed signaling bit) and store its value (‘1’ or ‘0’) in the least significant bit position (zero) of a first eight bit register stage. The processor then returns to the idle state until the bitNow port is at the MSB for the next time slot in the signaling frame. The shift register unit is shifted by one bit, and the new sample is stored.

This procedure is repeated for all twenty-four time slots TS-1-TS-24 of the signaling frame are stored. After channel twenty-four, the contents of the shift register are frozen. This process is repeated for every sixth-frame. In D4/SF format, signaling bits are sampled for frames six and twelve. In ESF format, signaling bits are extracted from frames six, twelve, eighteen and twenty-four. The sampled and stored signaling bits are transferable to separate memory for archival storage and analysis.

For E1 mode, time slot sixteen of every frame is reserved for signaling bits. Fifteen of the sixteen frames of a sixteen frame E1 multi-frame may be used for robbed signaling bits. The single exception is the first frame. As noted above, in this frame, time slot sixteen (TS-16) is reserved for framing purposes. For each of the frames where time slot sixteen is available for signaling bits, the eight bits of time slot sixteen are divided into two groups. The first half (four LSBs) of every time slot sixteen byte of fifteen successive frames (F1-F15) is assigned to the signaling bits associated with voice channels one through fifteen. The second half (four MSBs) of every byte of time slot sixteen byte of those fifteen successive frames (F1-F15) is assigned to the signaling bits associated with voice channels sixteen through thirty.

In E1 mode, the processor monitors every incoming frame. In time slot sixteen, the processor will sample every bit. The eight sampled bits represent the signaling bits for two voice channels. For example, time slot sixteen of frame one contains the signaling bits for two voice channels—channel one and channel sixteen. Namely, the first four bits of time slot sixteen of the second frame are allocated to voice channel one and the second four bits of time slot sixteen for that frame are allocated to voice channel sixteen. (The sole exception is the first frame which is reserved for framing bits, as noted above.) These bits are used for frame alignment and alarm indication. As a result, an E1 multi-frame will contain signaling bits for thirty voice channels. Thus, each register will contain the signaling bits for one frame. The bits may be latched in separate memory for archival storage and analysis.

In the transmitter subsystem's decoder unit is similar to that employed in the receiver subsystem, in that it monitors a set of control ports and selectively enables loading of a signaling bit shift register with signaling bits that are controllably inserted (multiplexed) into the transmitted data stream supplied from the data pump. For this purpose, first port of the transmitter's decoder is a multi-frame sync pulse (mfsync) supplied by the framer, to ensure alignment with the beginning of each successive multi-frame of data. A second, frameNumber, port specifies the current frame number. As in the receiver subsystem, for T1 mode, the processor remains idle until the frame Number port indicates the current frame is an integral multiple-of-six frame. A third, channel, port specifies the channel number into which a respective signaling bit is to be inserted (TS1-TS24 for T1 mode and TS1-TS16 for E1 mode). A fourth, bitNow, port indicates the actual bit location within a time slot where the signaling bit is to be inserted. For a T1 frame, it is not until this port specifies the MSB of a signaling frame (every sixth frame) time slot, that a signaling bit may be inserted. A fifth, frame type, control bit cT1E1Not is supplied represents whether the data frame is a T1 frame or an E1 frame. Associated with the control bit cT1E1Not is a sixth, cEsfSfNot/cCasCccsNot port, which is used as an alignment indicator for framing (cEsfSfNot for a T1 frame; cCasCccsNot for an E1 frame). A seventh, rBits_en/tsBits_en, port serves as a signaling bit insertion enable input. An eighth, tsIoNot port is used in E1 mode to allow an external controller to selectively choose which signaling bits should be inserted. A ninth, cAIS port provides an optional Alarm Indication Signal (AIS) feature exclusively for E1 mode. When the cAIS input is asserted high the transmit subsystem will insert all ones in time slot sixteen. The decoder supplies a steering output to a signaling bit input multiplexer. This multiplexer has inputs that feed shift register stages signaling bits to be controllably inserted into the data stream

In the transmitter subsystem, signaling bits are controllably inserted into the data stream being supplied from the data pump by controllably reading out the contents of the signaling bit shift register unit into selected replacement or robbed bit positions of time slots of prescribed frames of data being transported over serial data path from the data pump. The time slots into which signaling bits are to be inserted are defined by the mode of operation (T1 mode or E1 mode). The exact location of where signaling bit insertion is to take place is determined by the frame Number, channel and bit Now.

For T1 mode, the signaling bits are serially shifted out and inserted in place of selected bits of the data stream supplied from the data pump at every sixth frame (frames F6, F12 for D4/SF and additional frames F18 and F24 for ESF), whenever the bitNow port to the decoder indicates the MSB position. In this manner, all twenty-four bits in a respective trio of registers are placed in the data stream for an associated sixth frame. T1 mode allows the external system to selectively choose which channel should have signaling bits inserted. Through the use of the transmit transparency bus bits, the user can indicate which channels should have signaling bits inserted. The bus has a bit for every channel, with the least significant bit corresponding to channel one. When the corresponding bit is high, the signaling bit will not be inserted. When signaling is desired, the corresponding bit must be set low. This feature is enabled whenever signaling is enabled.

In E1 mode, each register is loaded with signaling bits for one frame. The configuration software is used to insert the framing pattern into the first frame. The bits must be updated each multi-frame or signaling bits will be re-sent in subsequent frames. In E1 mode, signaling bits may only be inserted for Channel Associated Signaling (CAS) framing. When this requirement is met, the signaling bit storage register unit is used to insert the signaling bits in a manner similar to T1 mode, except that signaling bits are inserted every frame rather than every sixth frame. In the course of inserting signaling bits in the outgoing transmit path from the DTE to the network, if the register contents are not updated before the next multi-frame pulse, the same signaling bits will be re-sent in the next multi-frame.

E1 mode allows the external system to selectively choose which signaling bits should be inserted. This may be accomplished by using the transmit channel blocking registers. If the bit is ‘1’ then a signaling bit is inserted. Otherwise, the data pump stream is passed, ‘as is’. Also, in E1 mode the transmitter subsystem supports an optional Alarm Indication Signal (AIS) feature (not available in T1 mode). When the cAIS input to the decoder is pulled high, the transmitter subsystem will insert ones in all eight bit positions of time slot sixteen.

### BRIEF DESCRIPTION OF THE DRAWINGS

FIG. 1 is a time slot/channel diagram of a channelized T1 frame containing twenty-four, eight-bit time slots TS1-TS24, plus a frame sync bit, for a total of 193 bits per T1 frame;

FIG. 2 is a time slot/channel diagram of a respective E1 frame containing thirty-two, eight-bit time slots TS0-TS31;

FIG. 3 diagrammatically illustrates the architecture of the selectively programmable, network-DTE interface according to the invention described in the above-referenced '______ application;

FIG. 4 diagrammatically illustrates the architecture of a receiver subsystem of the shared T1/E1 signaling processor of the present invention; and

FIG. 5 diagrammatically illustrates the architecture of a transmitter subsystem of the shared T1/E₁ signaling processor of the present invention.

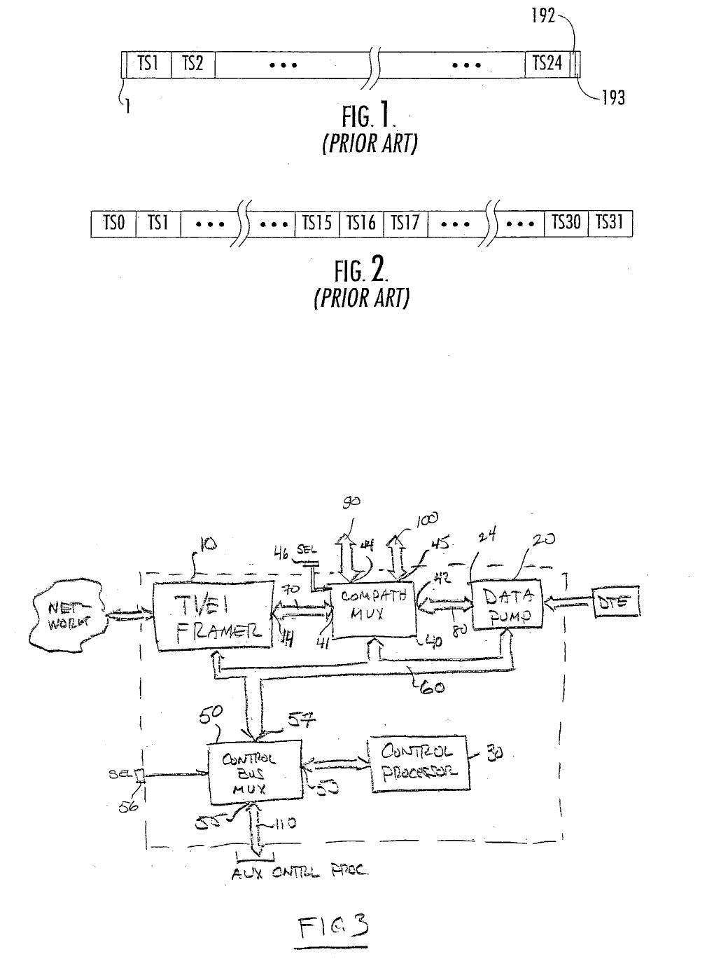

### DETAILED DESCRIPTION

Before describing in detail the new and improved shared T1/E1 signaling processor of the present invention, it should be observed that the invention resides primarily in what are effectively modular arrangements of conventional communication circuits and associated digital signal processing components and attendant supervisory control circuitry therefor, that controls the operations of such circuits and components. In a practical implementation that facilitates their incorporation into a telecommunication equipment bay or shelf, these modular arrangements may be readily implemented as digital application specific integrated circuit (ASIC) chip sets.

Consequently, the configuration of such circuits components and the manner in which they are interfaced with other communication system equipment have, for the most part, been illustrated in the drawings by readily understandable block diagrams, which show only those specific details that are pertinent to the present invention, so as not to obscure the disclosure with details which will be readily apparent to those skilled in the art having the benefit of the description herein. Thus, the block diagram illustrations are primarily intended to show the major components of the system in a convenient functional grouping, whereby the present invention may be more readily understood.

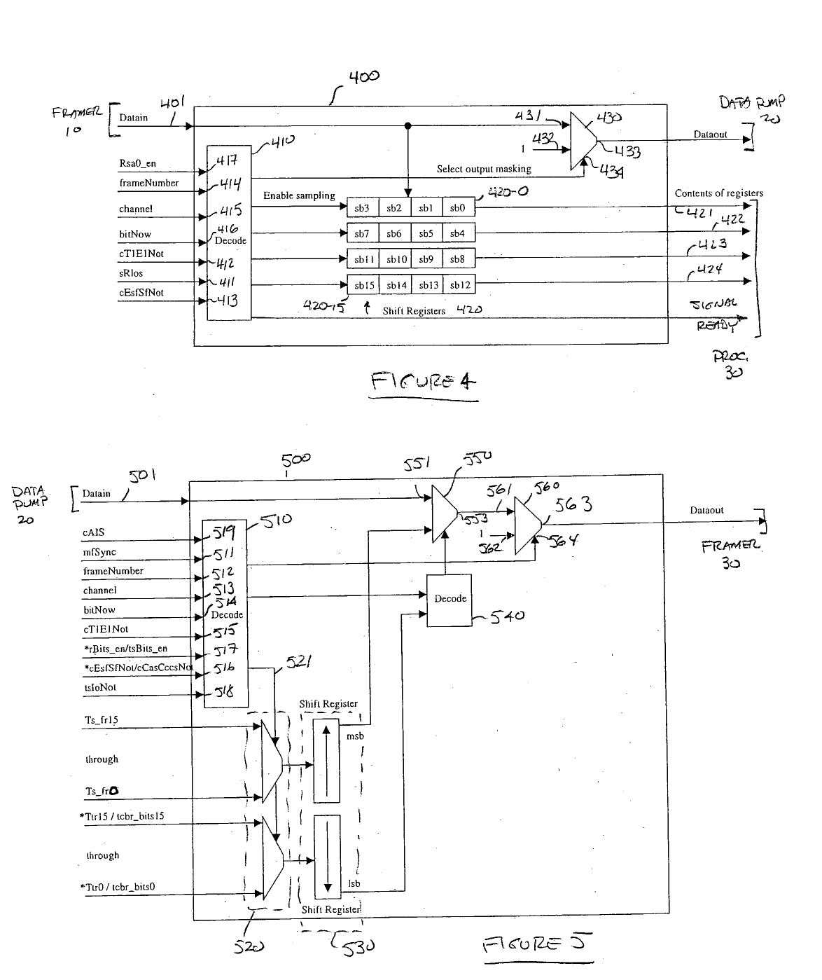

As pointed out briefly above, although the shared T1/E1 signaling processor of the present invention is intended to be used in essentially any application equipped for both T1 and E1 traffic, for purposes of providing a non-limiting example, the following description will address the incorporation of the invention in a selectively programmable, network-DTE interface of the type described in the above referenced '______ application, and illustrated diagrammatically in FIG. 3. As shown therein the interface contains a T1/E1 framer 10, a data pump 20, and a control processor 30, each of which conforms with industry standard design and performance requirements of a network-DTE interface, and is implemented in a common integrated, preferably a reasonably priced digital ASIC chip.

Additional functionality of the chip comprises a set of multiplexers, including a communication path multiplexer 40 installed between the framer 10 and the data pump 20, and a control bus multiplexer 50 installed between the microprocessor 30 and the address, data, control bus 60, through which the operations of the framer and data pump are normally controlled by the microprocessor 30. These multiplexers provide bidirectional connectivity between their signaling ports. Path selectivity through the respective multiplexers is externally programmable via a set of select pins, so as to provide the user with ability to selectively employ some or all of the functionality of the components of the interface.

The communication path multiplexer 40 has a first bidirectional signal port 41 coupled over a bidirectional digital data link 70 to bidirectional signaling port 14 of framer 10 (which would normally be coupled directly to bidirectional signaling port 24 of the data pump 20). To provide connection with the data pump 20, communication path multiplexer 40 has a second bidirectional signal port 42 coupled over a bidirectional digital data link 80 to bidirectional signaling port 24 of the data pump 20. Communication path multiplexer 40 further includes a pair of auxiliary ports 45 and 44, which provide alternative external connectivity to respective auxiliary signaling paths 90 and 100, when the multiplexer 40 is programmed to bypass the framer 10 and/or the data pump 20.

Where the connection from the framer to the data pump is to be interrupted, a set of select pins 46 are placed in a prescribed (framer data pump-bypass) logical state. Depending upon the voltage values (e.g., ground or +V) applied to selected ones of the select pins 46, the multiplexer 40 may decouple or interrupt connectivity with framer port 41, or it may couple framer port 41 to either of auxiliary ports 44 and 45, so as to selectively provide framer connectivity to one of the auxiliary paths 90 and 100. In a similar manner, connectivity with the data pump 20 may be interrupted by selectively opening data pump port 42, or providing connectivity from the data pump port 42 to either of auxiliary ports 44 and 45, and thereby selectively enabling data pump connectivity to one of the auxiliary paths 90 and 100. The two auxiliary ports 44 and 45 provides the communication path multiplexer 40 with the ability to selectively steer each of the framer 10 and data pump 20 to respectively targeted external digital communication paths, so that each of the framer and data pump may operate autonomously of the other.

In addition to allowing each of the framer 10 and data pump 20 to be selectively by-passed via the communication path multiplexer 40, the programmable network-DTE interface of FIG. 2 allows the user to selectively externally control the operation of the chip, through a control bus multiplexer 50 installed between the control processor 30 and the control bus 60. For this purpose, the control bus multiplexer 50 has a first bidirectional signaling port 53 coupled to the microprocessor 30, a second port 57 coupled to the control bus 60, and a third port 55 coupled to a bus 110, through which auxiliary control of the control bus 60 may be externally supplied. Like the communication path multiplexer 40, path selectivity through the control bus multiplexer 50 between the control bus 60 and either internal processor 30 or the auxiliary path 110 is externally programmable via a set of select pins 56.

As described briefly above, the shared T1/E1 signaling processor of the invention contains two subsystems, one being a receive subsystem, shown in FIG. 4, which has the ability to sample and extract the time slots incoming from the network to the DTE. The second, a transmit subsystem, shown in FIG. 5, has the ability to insert data into the time slots outgoing from the DTE to the network.

Receiver Subsystem

Attention is now directed to FIG. 4, which shows the architecture of the receiver subsystem 400 of the shared T1/E1 signaling processor, for use with a network-DTE interface of the type described above, and the manner in which it may be readily interfaced with the digital signaling transport path through the framer and data pump, so that signaling data may be extracted by the control processor. As shown in FIG. 4, the principal components of the receive portion of the shared T1/E1 signaling processor 400 include a signaling bit extraction decoder unit 410, a shift register unit 420 and a data overwrite multiplexer 430.

As will be described, the signaling bit extraction decoder unit 410 monitors a set of control links from the framer and the processor, and selectively enables the loading of selected registers of the shift register unit 420 with sampled portions of the received data stream containing the signaling bits as received over a Data_in line 401, which is coupled to a first input port 431 of multiplexer 430. After passing through several other components, the output port 433 of multiplexer 430 is coupled to the data pump. To accommodate both T1 and E1 frames, shift register unit 420 is comprised of sixteen, byte-deep registers.

For the case of T1 SF format, the robbed (MSBs) of the twenty-four time slots (TS1-TS24) of the sixth frame (F6) of data received over the Data_in line 401 will be sequentially loaded into the sb0, sb1 and Sb2 registers 420-0, 420-1 and 420-2, respectively. Likewise, the robbed (MSBs) of the twenty-four time slots (TS1-TS24) of the next sixth (twelfth) frame (F12) of data received over the Data_in line 401 will be sequentially loaded into the sb3, sb4 and Sb5 registers 420-3, 420-4 and 420-5, respectively, and so on.

For the case of T1 ESF format, the robbed (MSBs) of the twenty-four time slots (TS1-TS24) of the next sixth or eighteenth frame (F18) of data received over the Data_in line 401 will be sequentially loaded into the sb6, sb7 and Sb8 registers 420-6, 420-7 and 420-8, respectively, and the robbed (MSBs) of the twenty-four time slots (TS1-TS24) of the next sixth (twenty-fourth) frame (F24) of data received over the Data_in line 401 will be sequentially loaded into the sb9, sb10 and Sb11 registers 420-9, 420-10 and 420-11, respectively, and so on.

For the case of E1 format, multi (sixteen)-frame data received over the Data_in line 401, the eight robbed bits of time slot sixteen (TS-16) of frames F2F16 will be sequentially loaded into the sb1 through Sb15 registers 421-0-421-14, respectively. For the next successive multiframe, the eight robbed bits of time slot sixteen (TS-16) of the second frame F2 will be loaded into the Sb15 register 421-15, and so on.

In order to accurately control the extraction of the signaling bits from the incoming serial data stream, a number a control parameters are supplied to the signaling bit extraction decoder unit 410 from the framer and from the control processor. A first input 411 is a loss of sync bit sRlos supplied by the framer. In the event of loss of sync, the value of this bit is a logical ‘1’, instructing the processor to terminate signaling recovery. As long as the value of the sRlos bit is ‘0’, incoming data is valid for signaling recovery.

A second, frame type, control bit cT1E1Not is supplied to port 412 from the control processor and represents whether the data frame is T1 data or E1 data. Where the value of the cT1E1Not is a logical ‘1’ it is inferred that the frame is a T1 frame; on the other hand, where the value of the cT1E1Not is a logical ‘0’ it is inferred that the frame is an E1 frame. In association with the second control bit, a third, frame type control input CEsfSNot is supplied to port 413 from the control processor, and represents whether the T1 frame has superframe (SF) or extended superframe (ESF) format. For SF format, the CEsfSNot is a ‘0’; for ESF format, the CEsfSNot is a ‘1’.

The counter circuitry within the framer also supplies bit location to control the operation of the signaling bit storage registers. In particular, a fourth, frame number, port 414 is used to indicate the number of the current frame of data being processed. When in T1 mode of operation, the processor will remain idle until the frame Number port indicates the current frame is an integral multiple of sixth frame of a multi-frame sequence, as described above. A fifth, channel or time slot, port 415 from the framer indicates in which time slot a respectively received bit of a currently received frame of data resides. For each frame of T1 data, this value increments from TS1-TS24, whereas for each frame of E1 data this value increments from TS1-TS16. A sixth, bitNow port 416 from the framer indicates the location of the current data bit within a time slot. For a T1 data frame, it is not until this port specifies the MSB of signaling frame time slot, that the data on the link may be sampled as a valid signaling bit.

The signaling bit extraction decoder unit 410 has a seventh, Rsao-en, port 417 which is coupled to receive a T1 signal masking bit. When enabled by a high ‘1’ applied to port 417, the steering input 434 of multiplexer 430 couples a hard-wired logical ‘1’ at its second input 432 to its output 433. This bit is used to deliberately invoke a ‘1’ at each signaling position in the data stream.

Receiver Subsystem Operation

As described above, and as shown in FIG. 4, the data input to the T1/E1 signaling processor 400 is the serial data stream on the input link 401 from the upstream framer. Depending upon the type or mode of operation of the framer, this data stream will be either serial (SF or ESF) T1 data stream or a serial E1 data stream. As pointed out above, the mode of operation is established by the bit value of the cT1E1Not input 412 port (where a logical 1′ represents a T1 frame; a ‘0’ represents an E1 frame). Once frame sync has been acquired, the SRlos input 411 goes low, so that sampling of the data stream may proceed. The sampling clock (not shown) is aligned with the input data stream (e.g., the data aligned with the rising edge of the clock).

T1 Mode

When in T1 mode of operation (SF or ESF), the T1/E1 signaling processor 400 remains idle, until the frame Number port 414 indicates that the current frame is the sixth frame of a multi-frame T1 sequence. At that time, the processor begins monitoring the bitNow port 416. When the value presented to the bitNow port 416 is the binary value ‘111’—corresponding to the most significant bit position of the first time slot or channel (as specified at channel port 415), the processor will sample the input data and store the value in the least significant bit position (zero) of the eight bit Sb0 register 420-0.

The processor will return to the idle state until the bitNow port 416 is “111” at the next time slot. At this time, the contents of shift register unit 420 are shifted (to the left) by one bit, and the new sample is stored. This procedure is repeated for all twenty-four channels or time slots TS-1-TS-24 of the sixth frame (F6). After channel twenty-four, the contents of the shift register are frozen. The preceding process is repeated for every sixth-frame. For example, as described above, in D4/SF mode, signaling bits are sampled for frames six and twelve. In Extended Super-Frame (ESF) mode, signaling bits are extracted from frames six, twelve, eighteen and twenty-four.

The sampled and stored signaling bits are accessed via registers sb0 through sb15 of shift register unit 420 via output links 421, 422, 423 and 424. The contents are valid at the time of the multi-frame synch pulse. The bits asserted onto links 421-424 may be latched in separate memory for archival storage and analysis. The output signals are the registers sb0 through sb15 and the serial data stream. For T1 mode, registers sb2 through sb0 will contain the signaling bits for frame six, with bit 7 of sb2 holding the signaling bit of time slot zero. Similarly, registers sb5 through sb3 hold the signaling bits of frame twelve; registers sb8 through sb6 hold the signaling bits of frame eighteen (frame six for D4) and registers sb11 through sb9 hold the signaling bits of frame twenty-four (frame twelve for D4).

E1 Mode

As pointed out above, for E1 mode, time slot sixteen of every frame is reserved for signaling bits. Fifteen of the sixteen frames of a sixteen frame E1 multi-frame may be used. The single exception is the first frame or frame (F0). In this frame, time slot sixteen (TS-16) is reserved for framing purposes. For each of the frames where time slot sixteen is used for signaling purposes, the eight bits of time slot sixteen are divided into two groups. The first half (four LSBs) of every time slot sixteen byte of fifteen successive frames (F1-F15) is assigned to the signaling bits associated with voice channels one through fifteen. The second half (four MSBs) of every byte of time slot sixteen byte of those fifteen successive frames (F1-F15) is assigned to the signaling bits associated with voice channels sixteen through thirty.

In E1 mode, the processor monitors every incoming frame. In time slot sixteen, indicated by the channel bus port as value “10000”, the processor will sample every bit. The eight bits that are sampled represent the signaling bits for two voice channels. For example, time slot sixteen of frame one contains the signaling bits for two voice channels—channel one and channel sixteen. Thus, as described above. the first four bits of time slot sixteen of the second frame (F1) are allocated to voice channel one and the second four bits of time slot sixteen for frame F1 are allocated to voice channel sixteen. The sole exception is the first frame (F0), which is reserved for framing bits, as described above. These bits are used for frame alignment and alarm indication. As a result, an E1 multi-frame will contain signaling bits for thirty voice channels. Thus, for E1 mode, each register will contain the signaling bits for one frame. Register sb0 holds the signaling bits for frame zero, . . . register sb15 holds the signaling bits for frame 15. The contents will be valid at the time of the multi-frame sync. The bits asserted onto links 421-424 may be latched in separate memory for archival storage and analysis.

Transmitter Subsystem

Attention is now directed to FIG. 5, which shows the architecture of the transmitter subsystem 500 of the shared T1/E1 signaling processor of the invention, and the manner in which signaling data may be inserted by the control processor for transport to the network. As shown in FIG. 5, the principal components of the transmitter subsystem include a signaling bit insertion decoder unit 510, a multiplexer unit 520, a shift register unit 530, and output decoder 540, an output multiplexer 550, and a data overwrite multiplexer 560.

Similar to the signaling bit extraction decoder unit 410 of the receiver subsystem, described above, signaling bit insertion decoder unit 510 is operative to monitor a set of control links from the framer and the processor, and selectively enable loading of signaling bit shift register unit 530 via multiplexer 520 with signaling bits to be inserted into the transmitted data stream supplied over a Data_in line 501 from the data pump, which is coupled to a first input port 551 of multiplexer 550. The output port 553 of multiplexer 550 is coupled to an input port 561 of a multiplexer 560, whose output 563 is eventually coupled to the framer.

In order to selectively control the replacement of data in the serial data stream from the data pump with signaling bits loaded into the shift register unit 530, a number of control parameters are supplied to the signaling bit insertion decoder unit 510 from the framer and from the control processor. A first port 511 is a multi-frame sync pulse (mfSync) supplied by the framer. This input serves to ensure alignment with the beginning of each successive multi-frame of data. A second, frameNumber, port 512 is used to specify the current frame number. As is the case with the receiver subsystem, for T1 mode, the processor remains idle until the frame Number port 512 indicates the current frame is an integral multiple-of-sixth frame of a multi-frame sequence. As noted above, for E1 mode, time slot sixteen of fifteen of the sixteen frames of a multi-frame is used for signaling bits. In the first frame or frame (F0), time slot sixteen (TS-16) is reserved for framing purposes.

A third, channel, port 513 specifies the timeslot (TS) or channel number into which a respective signaling bit is to be inserted. As in the receiver subsystem, in T1 mode, for each frame of outgoing T1 data, this value increments from TS1-TS24, whereas in E1 mode, for each frame of E1 data this value increments from TS1-TS16. A fourth, bitNow, port 514 from the framer indicates the actual bit location within a time slot where the signaling bit is to be inserted. For a T1 data frame, it is not until this port specifies the MSB of a signaling frame (every sixth frame) time slot, that a signaling bit may be inserted.

A fifth, frame type, control bit cT1E1Not is supplied to port 515 and represents whether the data frame is a T1 frame or an E1 frame. Where the value of the cT1E1Not is a logical ‘1’, the frame is a T1 frame; on the other hand, where the value of the cT1E1Not is a logical ‘0’, the frame is an E1 frame. Associated with control bit cT1E1Not is a sixth, cEsfSfNot/cCasCccsNot port 516, which is used as an alignment indicator for framing (cEsfSfNot for a T1 frame; cCasCccsNot for an E1 frame). A seventh, rBits_en/tsBits_en, port 517 serves as a signaling bit insertion enable input. An eighth, tsIoNot port 518 is used in E1 mode to allow an external controller to selectively choose which signaling bits should be inserted. To use this feature, the tsIoNot port 518 is asserted high. A ninth, cAIS port 519 provides an optional Alarm Indication Signal (AIS) feature exclusively for E1 mode. When the cAIS input is asserted high (in E1 mode only), the transmit subsystem 500 will insert all ones in time slot sixteen. This feature is not available in T1 operation.

The signaling bit insertion decoder 510 supplies a first steering output over link 521 to signaling bit multiplexer 520 which is coupled to shift register unit 530. Multiplexer 520 has a first set of register stage inputs Ts_fr0-Ts_fr15, that receive signaling bits for time slot sixteen for the respective sixteen frames of E1 mode. For example, bus ts-fr0 supplies signaling bits for frame zero, bus ts-fr1 supplies signaling bits for frame one, and so on through bus ts-fr15. Signaling bit multiplexer 520 has a second set of inputs Ttr0/tcbr_bits0-Ttr15/tcbr_bits15 through which an external controller may choose which voice channel signaling bits to insert. The least significant bit corresponds to the first four bits of time slot sixteen of frame zero. The next bit corresponds to the second four bits of the time slot and so on. This feature is enabled whenever signaling insertion is enabled.

Transmitter Subsystem Operation

In the transmitter subsystem of FIG. 5, signaling bits are controllably inserted into the data stream being supplied from the data pump over line 501, by controllably reading out the contents of the signaling bit shift register unit 530 into selected replacement time slots of prescribed frames of data being transported over serial data path 501 from the data pump. The time slots into which signaling bits are to be inserted are defined by the mode of operation (T1 mode or E1 mode). The exact location of where signaling bit insertion is to take place is determined by the frame Number, channel and bit Now.

The Frame Number is supplied to the frameNumber port 512 of decoder 510 to align the input bus with the input data stream. The frame number of the current frame, with respect to the multi-frame alignment, is indicated by this input. The channel indicator (at decoder channel input port 513) is used to indicate the current time slot of the frame, and should be aligned with the first bit of a time slot. Also required is the bit number indicator supplied to bit Now port 514; this input is used to indicate the location of the current data bit within a time slot. The external system must supply the signaling bits on the Ts-fr0 through Ts-fr15 input busses to multiplexer 520 through which the respective stages of the shift register unit 530 are loaded.

T1 Mode

For T1 mode, the frames are numbered one through twenty-four, and the channels or time slots in each frame are numbered one through twenty-four. The shift register unit 530 is loaded with signaling bits off the bus feeding the multiplexer 520 that are to be sequentially read out and inserted in place of selected bits of the data stream supplied from the data pump over line 501. At the beginning of every sixth frame (frames F6, F12 for D4/SF and additional frames F18 and F24 for ESF), the contents of corresponding Ts_fr mux inputs are loaded into the shift register unit 530.

In particular, within shift register unit 530, a first set of shift registers Ts_fr0 through Ts_fr2 is loaded with signaling bits for the first ‘sixth’ frame (frame six); a second set of shift registers Ts-fr3 through Ts_fr5 is loaded with signaling bits for the next ‘sixth’ frame (frame twelve); a third set of registers Ts_fr6 through Ts_fr8 is loaded with signaling bits for the next ‘sixth’ frame (frame eighteen); and a fourth set of registers Ts_fr9 through Ts_fr11 is loaded with signaling bits for the next ‘sixth’ frame (frame twenty-four).

Whenever the bitNow port 514 to the signaling bit insertion decoder 510 indicates the bit seven (MSB) position, the shift register unit 530 will shift out its contents one bit at a time. In this manner, all twenty-four bits in a respective trio of registers (Ts_fri-Ts_fr(i+2)) are placed in the data stream for an associated sixth frame Fj.

T1 mode allows the external system to selectively choose which channel should have signaling bits inserted. Through the use of the input bus ttr-bits, the user can indicate which channels should have signaling bits inserted. The bus has a bit for every channel, with the least significant bit corresponding to channel one. When the corresponding bit is high, the signaling bit will not be inserted. When signaling is desired, the corresponding bit must be set low. This feature is enabled whenever signaling is enabled.

E1 Mode

For E1 mode, each register is loaded with the signaling bits for one frame. As described above, for E1 mode, the sixteen frames are numbered zero through fifteen, and the thirty-two time slots are numbered zero through thirty-one. Even time slot sixteen of the first frame is subject to this control. For example, register Ts-fr0 is loaded with the signaling bits for frame zero, register Ts-fr1 is loaded with the signaling bits for frame one, and so on through register Ts-fr15 for frame fifteen. It is left to the configuration software to insert the framing pattern into the first frame. The bits must be updated every multi-frame or the signaling bits will be re-sent in subsequent frames.

In E1 mode of operation, signaling bits may only be inserted for Channel Associated Signaling (CAS) framing. When this requirement is met, the shift register unit 530 is used to insert the signaling bits in a manner similar to T1 mode described above, except that signaling bits are inserted every frame rather than every sixth frame. Namely, for every frame, the corresponding Ts-fr register bits are loaded into shift register 530. Via multiplexer 520, shift register 530 is loaded when the decoder input ports channel 513 and bitNow 514 indicate the final bit of time slot fifteen. For time slot sixteen, the shift register shifts to the left for each bit position. In this manner, all eight bits are inserted into the time slot, with the most significant bit of the Ts-fr register inserted first. In the course of inserting signaling bits in the outgoing transmit path from the DTE to the network, if the register contents are not updated before the next multi-frame pulse, the same signaling bits will be re-sent in the next multi-frame.

E1 mode allows the external system to selectively choose which signaling bits should be inserted. To use this feature, a high is asserted on the tsIoNot port 518 of the decoder. With the use of the tcbr-bits input bus to the multiplexer 520, the external system may choose which voice channel signaling bits to insert. The least significant bit corresponds to the first four bits of time slot sixteen of frame zero. The next bit corresponds to the second four bits of the time slot and so on. This feature is enabled whenever signaling is enabled.

As pointed out above, in E1 mode the transmitter subsystem supports an optional Alarm Indication Signal (AIS) feature (not available in T1 mode). When the cAIS input 519 to the signaling bit insertion decoder 510 is pulled high, the steering link from decoder 510 to multiplexer 560 connects output 563 to the second input 562, which is hardwired to a logical ‘1’, so that the transmitter subsystem will insert ones in all eight bit positions of time slot sixteen.

As will be appreciated from the foregoing description, the shared T1/E1 signaling bit processor of the present invention is configured to be interfaced with either T1 or E1 traffic, and is operative to controllably perform robbed bit signal extraction and insertion for T1/E1 signaling protocol using a common set of input/output circuitry and associated decode/control logic therefor. The receiver subsystem controllably samples and extracts signaling bits from selected time slots within serial frames of data incoming from the network to the DTE for delivery to the control processor, while the transmitter subsystem controllably inserts signaling bits into selected signaling channels of serial frames of data outgoing from the DTE to the network.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

What is claimed:

1. A communication apparatus for interfacing robbed signaling bits with respect to serial digital communication signals transported over a serial communication path comprising:
a signaling bit capture memory that is configured to receive and store signaling bits extracted from serial digital communication signals having different signaling protocols; and
a receiver subsystem processor configured to be coupled with said serial communication path and said signaling bit capture memory and being operative to controllably extract robbed bit signals from serial digital communication signals having any of said different signaling protocols and stored extracted robbed bit signals in said signaling bit capture memory.

2. The communication apparatus according to claim 1, further including a transmitter subsystem processor configured to be coupled with said serial communication path and being operative to controllably perform robbed bit signal insertion into serial digital communication signals having any of said different signaling protocols.

3. The communication apparatus according to claim 2, wherein said transmitter subsystem processor includes a common memory into which signaling bits to be inserted into serial digital communication signals having any of said different signaling protocols are controllably stored and read out for insertion into robbed signaling bit locations of said serial digital communication signals.

4. The communication apparatus according to claim 2, wherein said different signaling protocols include T1 and E1 digital communication signal protocols.

5. The communication apparatus according to claim 2, wherein said a signaling bit capture memory of said receiver subsystem processor includes a register into which robbed signaling bits contained in said serial digital communication signals are selectively written, in accordance with the operation of a robbed signaling bit extraction decoder, which is configured to monitor said serial digital communication signals and to identify locations of signaling bits therein based upon a prescribed set of signaling protocol, frame, channel and signaling bit location relationships supplied thereto.

6. The communication apparatus according to claim 3, wherein said common memory of said transmitter subsystem processor includes a register into which signaling bits are controllably stored for controlled insertion into said serial digital communication signals, and are read out therefrom and controllably multiplexed into said serial digital communication signals in accordance with the operation of an insertion decoder, which is configured to monitor said serial digital communication signals and to identify locations of signaling bits therein based upon a prescribed set of signaling protocol, frame, channel and signaling bit location relationships supplied thereto.

7. The communication apparatus according to claim 1, wherein said receiver subsystem processor is operative to controllably overwrite selected bits of said serial digital communication signals.

8. The communication apparatus according to claim 2, wherein said transmitter subsystem processor is operative to controllably overwrite selected bits of said serial digital communication signals.

9. A communication apparatus for interfacing robbed signaling bits with respect to serial digital communication signals transported over a serial communication path comprising:
a signaling bit memory that is configured to receive and store signaling bits for insertion into serial digital communication signals having any of a plurality of different signaling protocols; and
a transmitter configured to be coupled with said serial communication path and said signaling bit memory and being operative to controllably perform robbed bit signal insertion from said memory into serial digital communication signals having any of said plurality of different signaling protocols.

10. The communication apparatus according to claim 9, wherein said signaling bit memory of said transmitter includes a register into which signaling bits are controllably stored for controlled insertion into said serial digital communication signals, and are read out therefrom and controllably multiplexed into said serial digital communication signals in accordance with the operation of an insertion decoder, which is configured to monitor said serial digital communication signals and to identify locations of signaling bits therein based upon a prescribed set of signaling protocol, frame, channel and signaling bit location relationships supplied thereto.

11. The communication apparatus according to claim 9, wherein said different signaling protocols include T1 and E1 digital communication signal protocols.

12. A method for interfacing robbed signaling bits with respect to serial digital communication signals transported over a serial communication path comprising the steps of:
(a) providing a signaling bit capture memory that is configured to receive and store signaling bits extracted from serial digital communication signals having different signaling protocols; and
(b) performing robbed bit signal extraction from serial digital communication signals transported over said serial communication path having any of said differing signaling protocols and storing said signaling bits in aid signaling bit capture memory;
(c) providing a signaling bit read out memory which is configured to store signaling bits for insertion into serial digital communication signals having any of said different signaling protocols; and
(d) controllably inserting signaling bits stored in said signaling bit read out memory in step (c) into serial digital communication signals having any of said different signaling protocols.

13. The method according to claim 12, wherein said different signaling protocols include T1 and E1 digital communication signal protocols.

14. The method according to claim 12, wherein said signaling bit capture memory includes a register into which signal bits contained in said serial digital communication signals are selectively written in step (a), in accordance with the operation of an extraction decoder that monitors said serial digital communication signals and identifies locations of signaling bits therein based upon a prescribed set of signaling protocol, frame, channel and signaling bit location relationships supplied thereto.

15. The method according to claim 12, wherein said signaling bit read out memory includes a register into which signaling bits are controllably stored for controlled insertion into said serial digital communication signals, and are read out therefrom and controllably multiplexed into said serial digital communication signals in accordance with the operation of an insertion decoder that monitors said serial digital communication signals and identifies locations of signaling bits therein based upon a prescribed set of signaling protocol, frame, channel and signaling bit location relationships supplied thereto.

16. The method according to claim 12, wherein step (a) further includes controllably overwriting selected bits of said serial digital communication signals.

17. The method according to claim 12, wherein step (d) further includes controllably overwriting selected bits of said serial digital communication signals.
